(19) United States
(12) Patent Application Publication
(10) Pub. No.: US 2010/0225535 A1
(43) Pub. Date: Sep. 9, 2010

(54) TARGET OBJECT POSITION EVALUATION DEVICED USED IN SPORT EVENTS

(76) Inventor: Yi-Yang LI, Jhubei City (TW)

Correspondence Address: Muncy, Geissler, Olds & Lowe, PLLC, 4000 Legato Road, Suite 310, FAIRFAX, VA, 22033, US

(21) Appl. No.: 12/396,953

(22) Filed: Mar. 3, 2009

(51) Int. Cl. G01S 19/51; A63B 57/00

(52) U.S. Cl. 342/357.34; 473/407

(57) ABSTRACT

A target object position evaluation device of the present invention that is used at sport events includes a central processing unit (CPU), a global positioning system (GPS) module, an environment detection unit, a memory and a display device. In addition to the positioning function, the target object position evaluation device further uses the environment detection unit to collect various kinds of environmental information and estimate the mechanics of a motion trajectory in the CPU to provide better shooting information to a user, so that the user can easily obtain the shooting information such as the striking or shooting information required in an exercising process. In addition to the fitness effect, the user also can achieve a better result and gain more fun from the exercising process.

### FIELD OF THE INVENTION

The present invention relates to a target object position evaluation device used at sport events, and more particularly to a target object position evaluation device that integrates an environment detection unit with a positioning device.

### BACKGROUND OF THE INVENTION

Nowadays, people pay more attentions to leisure and sport activities in our busy industrial and commercial society, and thus sport equipments of various sports bloom. To achieve the best effect and result of an exercise or a sport, exercisers have to accurately control different factors of sport facilities in an exercise, as a result, the sport accessories become more important day after day.

At present, global positioning system (GPS) has been used extensively in different areas of our life, and the GPS is used a constellation of satellites high above the earth to determine a precise position of a satellite signal receiver on the earth's surface, and one of the common applications is the automobile navigation. In addition to the automobile navigation, GPS is also applied in the various sport accessories, and the precise positioning function of the GPS can be used for estimating a distance between an exerciser holding a positioning device and a target object for the exerciser's reference.

In a GPS applied to a sport or a leisure activity such as a golf sport, position coordinates information of all golf holes in a golf court are inputted into a positioning device in advance. If a golf striker is standing at a ball striking point, the positioning device will be able to immediately detect the position coordinates of the current ball striking point and calculate the distance between the ball striking point and the target golf hole as a reference for the striker to select a golf club and a striking force.

However, the reference value of the distance between a target object and a shooting object is insufficient for an exercise (such as golf sport, archery and shooting, etc) because the flying trajectory of the shooting object such as a golf, an arrow shaft and a bullet will be affected by the environmental information including the current wind direction and the wind speed to change the final hit point.

Therefore, it is an important subject for the present invention to provide an evaluation device capable of positioning an object and integrating environmental information for a user's reference.

### SUMMARY OF THE INVENTION

In view of the aforementioned shortcomings of the conventional positioning device used at sport events, the inventor of the present invention based on years of experience in the related industry to conduct extensive researches and experiments, and finally developed a target object position evaluation device capable of positioning objects and integrating a detection unit for connecting various kinds of environmental information to estimate the mechanics of a motion trajectory and provide better shooting information to users.

Therefore, it is a primary objective of the present invention to provide a target object position evaluation device used at sport events, wherein an evaluation device is used to evaluate a hit between a shooting object and a target object. The evaluation device comprises: a central processing unit (CPU); a GPS module, electrically coupled to the CPU, for receiving a satellite signal to position the evaluation device and outputting coordinates information of the evaluation device; an environment detection unit, electrically coupled to the CPU, for outputting detected environmental information; and a memory, electrically coupled to the CPU, for storing coordinates information of the target object, physical information of the shooting object and an evaluation program, wherein the evaluation program is provided for operating the CPU to estimate the coordinates information of the evaluation device, the environmental information, the coordinates information of the target object and the physical information of the shooting object, and drive the CPU to output an evaluation result; and the evaluation result is shooting information required for hitting the target object by the shooting object.

To achieve the foregoing objective, the present invention provides a target object position evaluation device used at sport events, wherein the target object position evaluation device is used in a golf sport, and an evaluation device is used for evaluating a hit between a golf ball and a golf hole target. The evaluation device comprises: a CPU; a GPS module, electrically coupled to the CPU, for receiving a satellite signal to position the evaluation device, and outputting coordinates information of the evaluation device; an environment detection unit, electrically coupled to the CPU, for outputting detected environmental information; and a memory, electrically coupled to the CPU, for storing coordinates information of the golf hole target, physical information of the golf ball and an evaluation program, wherein the evaluation program is provided for operating the CPU to estimate the coordinates information of the evaluation device, the environmental information, the coordinates information of the golf hole target and the physical information of the golf ball and driving the CPU to output an evaluation result; wherein the evaluation result is the ball striking information required for hitting the golf hole target by the golf ball.

In a preferred embodiment of the present invention, the physical information of the shooting object includes the weight of the shooting object, and the environmental information includes at least one selected from wind speed information and wind direction information, and the evaluation result includes at least one selected from shooting angle, shooting location and initial shooting speed.

A preferred embodiment of the present invention further comprises a display device, electrically coupled to the CPU, for displaying the evaluation result, and an input device, electrically coupled to the CPU, and provided for users to operate the evaluation device, wherein the input device is a touch panel integrated with the display device.

A preferred embodiment of the present invention further comprises a voice output device, electrically coupled to the CPU, for playing the evaluation result.

Therefore, users can easily obtain the shooting information such as the striking or shooting information required in the exercise to achieve a better result and gain more fun in the exercise, in addition to the fitness effect of the exercise.

### BRIEF DESCRIPTION OF THE DRAWINGS

FIG. 1 is a functional block diagram of an evaluation device in accordance with a preferred embodiment of the present invention; and

FIG. 2 is a flow chart of an operation of an evaluation device used in a golf sport in accordance with a preferred embodiment of the present invention.

### DESCRIPTION OF THE PREFERRED EMBODIMENT

Other features and advantages of the present invention will become apparent in the following detailed description of the preferred embodiments with reference to the accompanying drawings.

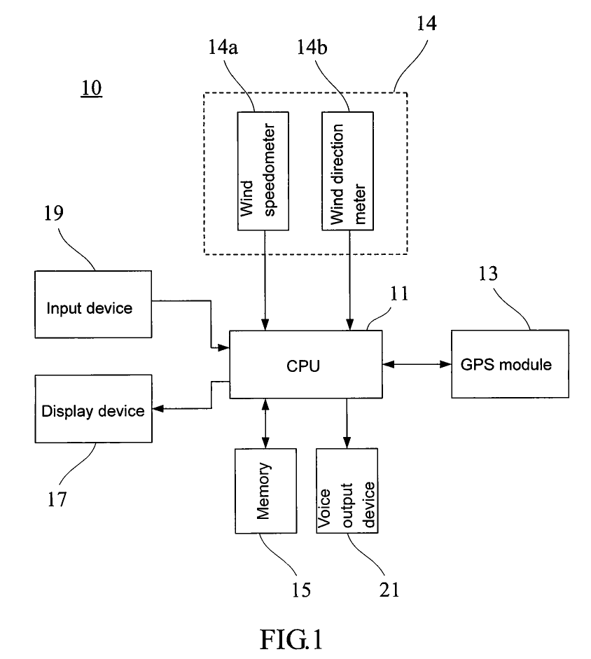

With reference to FIG. 1 for a functional block diagram of an evaluation device in accordance with a preferred embodiment of the present invention, the target object position evaluation device used at sport events uses an evaluation device 10 to evaluate a hit between a shooting object and a target object, and the evaluation device 10 comprises: a CPU 11, a GPS module 13, an environment detection unit 14, a memory 15, a display device 17, an input device 19 and a voice output device 21. In a preferred embodiment of the present invention, the evaluation device 10 can be held, used and carried by users, and the shooting object is a golf ball, an arrow shaft or a bullet, etc, and the target object is a golf hole target, an arrow target or a dart target, etc.

The CPU 11 is a console for computing and evaluating each of the various inputted information.

The GPS module 13 is electrically coupled to the CPU 11 for receiving a satellite signal above the earth's surface to position the evaluation device 10, and outputting the coordinates information of the evaluation device 10 to the CPU 11.

The environment detection unit 14 is electrically coupled to the CPU 11 for outputting detected environmental information to the CPU 11. In a preferred embodiment of the present invention, the environment detection unit 14 includes a wind speedometer 14a and a wind direction meter 14b for outputting wind speed information and wind direction information to the CPU 11. In a preferred embodiment of the present invention, the environment detection unit 14 includes the wind speedometer 14a or the wind direction meter 14b exclusively. The wind speedometer 14a is a thermal sensing type wind speedometer or a thermal bulb type wind speedometer that can be cooled by wind to produce a change of resistance, or a vane type wind speedometer that measures the wind speed by counting the number of rotations of the vane. The wind direction meter 14b is composed of a pointing device that changes its pointing direction according to a wind direction and a varistor whose resistance value varies with different wind directions for obtaining an indication of a wind direction. The memory 15 is electrically coupled to the CPU 11 for storing coordinates information of the target object, physical information of the shooting object, and an evaluation program. The evaluation program is provided for operating the CPU 11 to perform a mechanical estimation to the coordinates information of the evaluation device 10, the environmental information, the coordinates information of the target object, and the physical information of the shooting object. Such estimation is performed according to a formula related to the laws of motion and written into the evaluation program. The coordinates information can be used for estimating the distance between the evaluation device 10 and the target object, and then using the physical information such as the weight of the shooting object to estimate a shooting angle and an initial shooting speed according to the formula related to the laws of motion. The environmental information mainly includes a revised item such as wind direction and wind speed that will deviate the flying of the shooting object, and air pressure that will increase or shorten the flying distance of the shooting object, wherein the revised item can be revised by a real-time computation or by a lookup table. After the revision takes place, the revised item will be able to evaluate and provide better shooting information and finally output an evaluation result to the CPU 11.

In a preferred embodiment of the present invention, if the environmental information includes the wind speed information and the wind direction information, the evaluation result can be at least one of the shooting angle, the shooting location and the initial shooting speed or a combination of the above. If the environmental information includes the wind direction information only, then the evaluation result can be a shooting location; if the environmental information includes the wind speed information only, then the evaluation result can be an initial shooting speed. The physical information of the shooting object can be the weight of the shooting object estimated by the density and volume of the shooting object.

The display device 17 is electrically coupled to the CPU 11 for displaying the evaluation result outputted by the CPU 11. In a preferred embodiment of the present invention, the display device 17 is a liquid crystal display device having a graphic interface for displaying various types of information.

The input device 19 is electrically coupled to the CPU 11 and provided for users to operate the evaluation device 10 through the graphic interface. In a preferred embodiment of the present invention, the input device 19 is a touch panel integrated with the display device 17 for facilitating user's operations.

The voice output device 21 is electrically coupled to the CPU 11 for playing the evaluation result outputted by the CPU 11 by using a voice guidance method. Therefore, users no longer need to view the display device 17 downward to obtain the shooting information required for hitting the target object by the shooting object anymore.

The present invention can be applied in various sport events such as golf, archery and shooting, etc. The application of the invention applied in golf is used for illustrating the operation of the evaluation device 10 as follows.

An evaluation device 10 is used at a golf sport to perform a hit evaluation between a golf ball and a golf hole target, and the evaluation device 10 comprises: a CPU 11; a GPS module 13, electrically coupled to the CPU 11, for receiving a satellite signal to position the evaluation device 10, and outputting coordinates information of the evaluation device 10; an environment detection unit 14, electrically coupled to the CPU 11, for outputting detected environmental information; a memory 15, electrically coupled to the CPU 11, for storing coordinates information of the golf hole target, physical information of the golf ball and an evaluation program, wherein the evaluation program is provided for operating the CPU 11 to estimate the coordinates information of the evaluation device 10, the environmental information, the coordinates information of the golf hole target and the physical information of the golf ball and driving the CPU 11 to output an evaluation result; and a display device 17, electrically coupled to the CPU 11, for displaying the evaluation result; wherein the evaluation result is the ball striking information required for hitting the golf hole target by the golf ball.

In a preferred embodiment of the present invention, the physical information of the golf ball includes the weight of the golf ball. The environment detection unit includes a wind speedometer 14a and a wind direction meter 14b. The evaluation result includes at least one selected from a ball striking direction, a ball striking force and the most preferable golf club. The memory 15 is used for storing specifications of various golf clubs.

In a preferred embodiment related to an application of the present invention applied in a golf sport, a lookup table pre-installed in the memory 15 is used for revising environmental information after the environmental information is inputted into the memory 15. The lookup table is used for illustrating this preferred embodiment. Table 1 shows the relation between a predetermined flying distance and a revised distance at a wind speed:

TABLE 1

| | | | | | | | |
|---|---|---|---|---|---|---|---|
| Predetermined Flying | 30 | 50 | 70 | 90 | 110 | 140 | 170 |
| Distance (Yd) | | | | | | | |
| Revised Distance (Yd) | 1.0 | 1.5 | 2.0 | 2.5 | 3.0 | 3.5 | 4.5 |
| at Wind Speed 1(m/s) | | | | | | | |

In Table 1, the predetermined flying distance refers to the distance between the current ball striking point and the golf hole target, and the wind direction is in the same direction of the flying direction provided that the wind speed is 1 (m/s), and a revised distance made in these conditions is used for the illustration. If the predetermined flying distance is equal to 140 yards, then the revised flying distance is equal to 143.5 yards provided that the wind direction is the same as the flying direction and the wind speed is equal to 1 (m/s). Therefore, a user has to strike a golf ball to a distance of 136.5 yards to reach the golf hole target. Therefore, the evaluation result outputted by the evaluation device 10 will recommend the user to use an appropriate golf club for striking the golf ball to a distance of 136.5 yards, and an appropriate force (such as strong, medium, and weak as classified for different striking distances of various golf clubs) applied onto the golf club. The memory 15 also stores a corresponding relation of various wind directions provided for the evaluation device 10 to output an appropriate evaluation result.

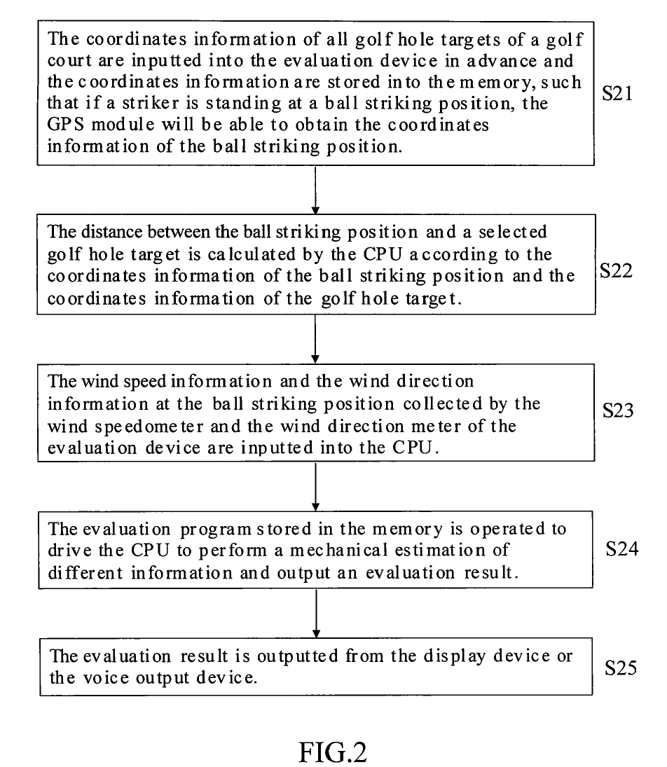

With reference to FIG. 2 for a flow chart of an operation of an evaluation device used in a golf sport in accordance with a preferred embodiment of the present invention, Step S21: the coordinates information of all golf hole targets of a golf court are inputted into the evaluation device 10 in advance, and the coordinates information are stored into the memory 15, such that if a striker is standing at a ball striking position, the GPS module 13 will be able to obtain the coordinates information of the ball striking position (which is also the coordinates information of the evaluation device 10).

Step S22: the distance between the ball striking position and a selected golf hole target is carefully calculated by the CPU 11 according to the coordinates information of the ball striking position and the coordinates information of the golf hole target.

Step S23: the wind speed information and the wind direction information at the ball striking position collected by the wind speedometer 14a and the wind direction meter 14b of the evaluation device 10 are inputted into the CPU 11.

Step S24: the evaluation program stored in the memory 15 is operated to drive the CPU 15 to perform a mechanical estimation of different information and output an evaluation result.

Step S25: the evaluation result is outputted from the display device 17 or the voice output device 21.

Therefore, the application of the present invention applied in a golf sport takes the factors including the wind speed and the wind direction that will affect the flying trajectory of the golf ball into consideration to provide better ball striking direction and ball striking force to a striker, wherein the ball striking force refers to the distance between the golf club and the golf hole target recommended to the striker. Since different types of golf clubs come with different loft angles and maximum ball striking distances, therefore the striker can strike a golf ball to a different extent according to the distance between the golf club and the golf hole target.

While the invention has been described by means of specific embodiments, numerous modifications and variations could be made thereto by those skilled in the art without departing from the scope and spirit of the invention set forth in the claims.

What is claimed is:

1. A target object position evaluation device used at sport events, for performing a hit evaluation between a shooting object and a target object, and the evaluation device comprising:
a central processing unit (CPU);
a global positioning system (GPS) module, electrically coupled to the CPU, for receiving a satellite signal to position the evaluation device, and outputting coordinates information of the evaluation device;
an environment detection unit, electrically coupled to the CPU, for outputting detected environmental information; and
a memory, electrically coupled to the CPU, for storing coordinates information of the target object, physical information of the shooting object and an evaluation program, and the evaluation program being provided for operating the CPU to estimate the coordinates information of the evaluation device, the environmental information, the coordinates information of the target object and the physical information of the shooting object, and driving the CPU to output an evaluation result;
wherein, the evaluation result is shooting information required for hitting the target object by the shooting object.

2. The target object position evaluation device used at sport events of claim 1, wherein the physical information of the shooting object includes weight of the shooting object.

3. The target object position evaluation device used at sport events of claim 1, wherein the environmental information comprises at least one selected from the collection of wind speed information and wind direction information.

4. The target object position evaluation device used at sport events of claim 1, wherein the evaluation result comprises at least one selected from the collection of a shooting angle, a shooting location or an initial shooting speed.

5. The target object position evaluation device used at sport events of claim 1, further comprising a display device electrically coupled to the CPU for displaying the evaluation result.

6. The target object position evaluation device used at sport events of claim 5, further comprising an input device electrically coupled to the CPU and provided for users to operate the evaluation device.

7. The target object position evaluation device used at sport events of claim 6, wherein the input device is a touch panel integrated with the display device.

8. The target object position evaluation device used at sport events of claim 1, further comprising a voice output device electrically coupled to the CPU for playing the evaluation result.

9. A target object position evaluation device used at sport events, for performing a hit evaluation between a golf ball and a golf hole target in a golf sport, and the evaluation device comprising:
a central processing unit (CPU);
a global positioning system (GPS) module, electrically coupled to the CPU, for receiving a satellite signal to position the evaluation device, and outputting coordinates information of the evaluation device;
an environment detection unit, electrically coupled to the CPU, for outputting detected environmental information; and
a memory, electrically coupled to the CPU, for storing coordinates information of the golf hole target, physical information of the golf ball and an evaluation program, and the evaluation program being provided for operating the CPU to estimate the coordinates information of the evaluation device, the environmental information, the coordinates information of the golf hole target and the physical information of the golf ball, and driving the CPU to output an evaluation result;
wherein, the evaluation result is ball striking information required for hitting the golf hole target by the golf ball.

10. The target object position evaluation device used at sport events of claim 9, wherein the physical information of the golf ball includes weight of the golf ball.

11. The target object position evaluation device used at sport events of claim 9, wherein the environmental information includes at least one selected from the collection of wind speed information and wind direction information.

12. The target object position evaluation device used at sport events of claim 9, wherein the environment detection unit includes a wind speedometer and a wind direction meter.

13. The target object position evaluation device used at sport events of claim 9, wherein the evaluation result comprises at least one selected from the collection of a ball striking direction, a ball striking force and a best-fit golf club.

14. The target object position evaluation device used at sport events of claim 9, further comprising a display device electrically coupled to the CPU for displaying the evaluation result.

15. The target object position evaluation device used at sport events of claim 14, further comprising an input device electrically coupled to the CPU and provided for a user to operate the evaluation device.

16. The target object position evaluation device used at sport events of claim 15, wherein the input device is a touch panel integrated with the display device.

17. The target object position evaluation device used at sport events of claim 9, further comprising a voice output device electrically coupled to the CPU for playing the evaluation result.

18. The target object position evaluation device used at sport events of claim 9, wherein the memory stores various kinds of golf club specifications.
